(19) United States
(12) Patent Application Publication
(10) Pub. No.: US 2013/0020446 A1
(43) Pub. Date: Jan. 24, 2013

(54) RETAINING RAIL FOR ACCOMMODATING A HEATING PIPE

(71) Applicant: Wolfram Winkler, Uberlingen (DE)

(72) Inventor: Wolfram Winkler, Uberlingen (DE)

(73) Assignee: Winkler Technik GMBH, Uberlingen (DE)

(21) Appl. No.: 13/574,998

(22) PCT Filed: Dec. 9, 2010
(86) PCT No.: PCT/EP10/07476

§ 371 Date: Oct. 9, 2012

(30) Foreign Application Priority Data
Jan. 25, 2010 (DE) 102010005779.7

(51) Int. Cl. F16L 3/02

(52) U.S. Cl. 248/49

(57) ABSTRACT

For a retaining rail for accommodating a heating pipe of an underfloor heating system, comprising at least one side wall (2.1, 2.2), wherein a holder (4.1, 4.2) for accommodating the heating pipe is provided in the side wall (2.1, 2.2) and at least one hold-down mechanism (6) for fixing the heating pipe in place is associated with the holder (4.1, 4.2), the hold-down mechanism (6) should comprise at least one, preferably two fingers (8.1, 8.2), which move(s) when the heating pipe is inserted into the holder (4.1, 4.2).

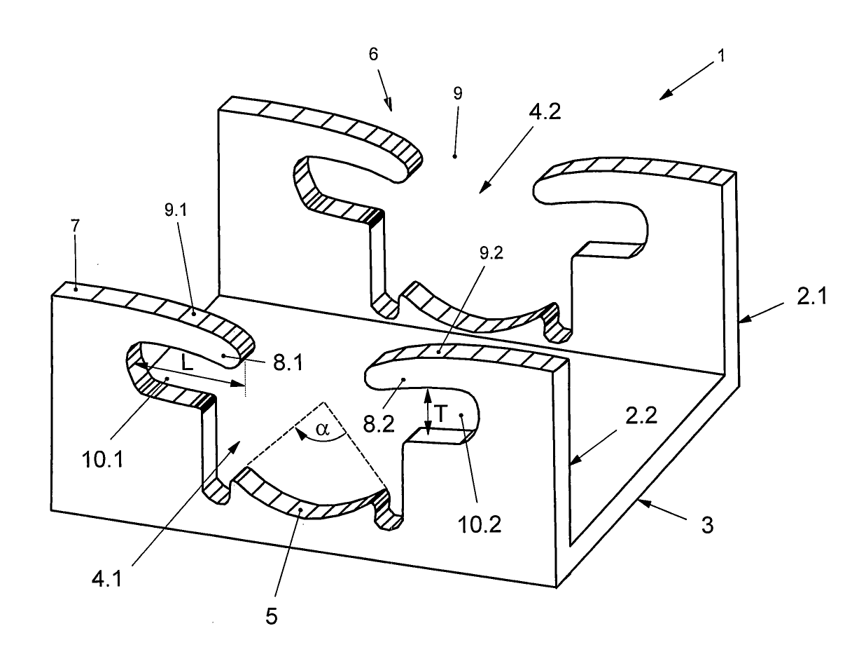

### TECHNICAL FIELD

The present invention refers to a support rail for receiving of a heating pipe of an underfloor heating comprising at least one side wall, wherein one receiving means for the receiving of the heating pipe is provided in the side wall, wherein at least hold-down mechanism aimed at fixing the heating pipe is correlated with the receiving means.

### STATE OF THE ART

When installing an underfloor heating, the heating pipes need to be fixated in accordance with an installation pattern before the screed is applied. To this end, various devices, such as support rails, retaining clips or the like are known.

Additionally, the DE 43 35 670 A1, for example, shows a support rail intended for heating pipes of an underfloor heating comprising an opening which is substantially shaped in a rectangular fashion, which opening serves to receive the heating pipe. In order to retain the heating pipe within the receiving means, a retaining collar is laterally arranged, which is supposed to narrow the opening. A secure fixing of the heating pipe is not possible with such a device, if forces or tensions take effect on the heating pipe, especially during the installation, because, for example, it is lead around a curve.

### OBJECT

The objective of the present invention is to create a support rail, with the aid of which a heating pipe, especially for underfloor heating systems, can reliably be fixated already during installation.

### SOLUTION OF THE OBJECT

The solution of the object is achieved in that the hold-down mechanism comprises at least one, preferably two, finger/s, which move/s into the receiving means when inserting the heating pipe.

Preferably, a finger extends approximately in parallel to a rim or a marginal edge of the side wall. In a preferred embodiment, the finger deviates slightly from the horizontal, so that an insertion chamfer is formed. This has the advantage that the heating pipe can more easily be inserted into the receiving means.

Expediently, the finger is formed in that a recess is arranged under the finger. Said recess extends within the side wall beneath the finger and preferably has a length greater than its height. In this way, the finger receives its form. The advantage is that the receiving means can easily be stamped out of the support rail in one manufacturing step with the recess forming a finger and with a simple tool.

In a further embodiment, however, the finger can also be formed separately and be connected with the side wall. To this end, the finger is preferably formed as a spring, a small thin plate or the like.

The finger is, however, especially preferably formed out of the side wall in one piece and is formed elastically. I.e., it is deformable to a certain extent and, more particularly, it is resettable, so that it can be pressed away laterally in a downward direction during the insertion of the heating pipe. Thus, the hold-down mechanism is deactivated and the receiving means, respectively, the insertion opening is opened to such an extent that it can receive the pipe. When the pipe is positioned within the receiving means and the finger will be no longer subjected to compression force, the finger elastically deforms back again to its original position lying essentially parallel to the marginal edge. Then the finger protrudes over the heating pipe and holds it down.

Expediently, the receiving means comprises a locating surface. Especially preferably, said locating surface is curved similar to the surface of a heating pipe. This has the advantage that the heating pipe is not damaged or bent. Preferably, the bending of the locating surface extends to an angle of 90°.

At the intended installation of the support rail the side wall is essentially aligned vertically. Preferably, however, the support rail comprises two side walls, which suitably are connected by a floor strip. In this instance the floor strip can also be interrupted by recesses, which are meant to serve to achieve savings in weight respectively to receive fixing elements.

In an especially preferred embodiment, the support rail is formed as a U-profile. At the intended installation the floor strip points downwards. Expediently, the floor strip serves the fixing to a floor. The floor strip may also only be laid onto the floor or may be floatingly positioned on to the floor.

Especially preferably, each of the two side walls has at least one receiving means, wherein the receiving means lying opposite to each other are identical in form and design. This has the advantage that the heating pipe can be fixed at two points lying relatively close to each other.

Expediently, several receiving means, in each respective case, are provided within the side walls. Preferably, these receiving means are positioned at a distance, which corresponds to the installation pattern of the underfloor heating.

### DESCRIPTION OF DRAWING

Further advantages, details and characteristics of the invention may appear from the following description of preferred embodiments as well as from the drawing, said drawing showing in its only FIGURE a perspective illustration of a section from a support rail according to the invention.

### EMBODIMENT

The FIGURE shows a support rail 1 for receiving a heating pipe, not illustrated, belonging to an underfloor heating. The support rail 1 is formed as a U-profile in the longitudinal direction and has two side walls 2.1 and 2.2, which are connected via a floor strip 3.

In a correct installing position, the two side walls 2.1 and 2.2 point vertically upwards. The floor strip 3 ensures securing to an underground, respectively, may also only be laid on or be floatingly mounted.

In each of the side walls 2.1 and 2.2 respectively a receiving means 4.1 and 4.2 is provided. The receiving means 4.1 and 4.2, which lie opposite to each other, coincide in their form, i.e. they are identically manufactured, this not being a necessary condition. For this reason, only the receiving means 4.1 is described below in detail. Incidentally, in a side wall 2.1, respectively 2.2 several receiving means are in fact provided in longitudinal direction of the support rail 1. Assigned to these are corresponding receiving means within the side wall lying on the opposite side in each respective case.

The receiving means 4.1 has a locating surface 5 and a hold-down mechanism 6. The locating surface 5 is formed to be curved. In this instance, the locating surfaces extend over an angle α. In the present embodiment, the angle α has approximately 90°. However, in further embodiments, the angle may also extent over sections of angle of the arc.

The hold-down mechanism 6 comprises at least one, in the present embodiment two finger(s) 8.1 and 8.2 arranged essentially parallel to a rim 7 of the side wall 2.2 with insertion chamfers 9.1 and 9.2 pointing downwards, between which an insertion opening 9 is formed. The fingers 8.1 and 8.2 are spring like, respectively, elastically formed, i.e. in a certain region they can be deformed elastically, but also regain their original shape.

Preferably the fingers 8.1 and 8.2 are formed in that recesses 10.1 and 10.2 being approximately parallel to the edge 7 formed into the side wall 2.1. Thereby the recesses 10.1 and 10.2 are formed in such a manner that their length L is greater than their depth T. However, in this case as well, other forms are conceivable. The recesses 10.1 and 10.2 adjoin to the receiving means 4.1 Preferably, the receiving means 4.1 with the two recesses 10.1 and 10.2 is stamped out in one working step out of the side wall 2.1 possibly also with one tool.

The present invention functions in the following manner:

In distances, the support rails are positioned on a floor, on which the underfloor heating is also to be installed. For fixing a heating pipe, the latter is inserted into the receiving means 4.1 and 4.2 of the support rail 1. To this end, the heating pipe is initially applied on the insertion chamfers 9.1 and 9.2 of the fingers 8.1 and 8.2. Then, the heating pipe is pressed downwards. Thereby, also the elastic fingers 8.1 and 8.2 move laterally downwards and thus set free the receiving means 4.1 and enlarge the insertion opening 9, respectively; deactivate the hold-down mechanism 6. Thus, the heating pipe can slide into the receiving means 4.1 unto the locating surface 5.

When the heating pipe with its broadest diameter section has slid between the two fingers 9.1 and 9.2, the two fingers 9.1 and 9.2 elastically snap back into their original positions, as shown in the FIGURE. In this instance, they again lie relative parallel to the rim 7 over the receiving means 4.1 and narrow the insertion opening 9 in such a manner that the heating pipe cannot glide out of the receiving means 4.1 unintentionally.

In order to insert the heating pipe into the receiving means 4.2, the procedure is carried out analogously, possibly also simultaneously.

Within the scope of the invention is also included that only one single finger is provided, which finger at least partially grips over the receiving means 4.1, respectively 4.2. In this case, the finger is naturally formed to be longer, so that the insertion opening in its clear cross section remains approximately equal, shifted, however, to the left or to the right.

### LIST OF REFERENCES

1 Support rail

2 Side wall

3 Floor strip

4 Receiving means

5 Support surface

6 Hold-down mechanism

7 Rim

8 Finger

9 Insertion opening/insertion chamfer

10 Recess

T Depth

L Length

α Angle

1-25. (canceled)

26. A vacuum devolatilizer for polymer manufacturing or processing, the devolatilizer comprising:
a vacuum chamber having an inlet, an outlet, at least one vacuum port, and at least one stirrer shaft port configured to accept a stirrer shaft;
a stirrer shaft passing through the at least one stirrer shaft port and extending into the vacuum chamber, the stirrer shaft includes an agitator;
a stirrer shaft seal associated with each stirrer shaft port for sealing against the stirrer shaft, each stirrer shaft seal having an external portion outside of the vacuum chamber;
at least one motor located outside the vacuum chamber for rotating the shaft; and
an enclosure for blanketing the external portion of at least one stirrer shaft seal with a low oxygen content gas or vapor.

27. The devolatilizer of claim 26, wherein the agitator comprises one or more paddles.

28. The devolatilizer of claim 26, wherein the vacuum chamber includes two stirrer shaft ports, and the stirrer shaft extends through each of those two stirrer shaft ports.

29. The devolatilizer of claim 26, wherein the enclosure blankets the external portion of each stirrer shaft seal with a gas that is substantially non reactive with polyolefins, the enclosure extends around each stirrer shaft seal, the enclosure is mounted on the outside of the vacuum chamber, and the enclosure is provided with a supply of a gas or vapor.

30. The devolatilizer of claim 29, wherein each enclosure is configured to be maintained under a positive pressure of a low oxygen content gas.

31. The devolatilizer of claim 29, wherein each enclosure includes an inspection hatch.

32. The devolatilizer of claim 30, including a flow meter configured to monitor the flow of low oxygen content gas into one or both of the enclosures.

33. The devolatilizer of claim 26, wherein the vacuum chamber is substantially cylindrical and provided in horizontal orientation such that the axis of the cylinder lies in a horizontal plane, and the stirrer shaft extends substantially horizontally and coincides with axis of the cylinder.

34. The devolatilizer of claim 26, wherein each shaft seal comprises a packed seal, and the devolatilizer includes at least one oil injection pump for injecting lubricating oil into the packed seal.

35. The devolatilizer of claim 34, wherein each seal includes a packing comprising braided Kevlar fibers impregnated with PTFE or graphite.

36. The devolatilizer of claim 26, wherein the low oxygen content gas comprises nitrogen.

37. The devolatilizer of claim 26, wherein the internal volume of the vacuum chamber is at least 2 to 10 m³.

38. A process of removing volatile components from a concentrated polymer phase, the process comprising:
providing a vacuum devolatilizer comprising:
a vacuum chamber having an inlet, an outlet, at least one vacuum port, and at least one stirrer shaft port configured to accept a stirrer shaft;
a stirrer shaft passing through the at least one stirrer shaft port and extending into the vacuum chamber, the stirrer shaft including an agitator for agitating a concentrated polymer phase in the vacuum chamber;
a stirrer shaft seal associated with each stirrer shaft port for sealing against the stirrer shaft, each stirrer shaft seal having an external portion outside of the vacuum chamber; and
at least one motor located outside the vacuum chamber for rotating the stirrer shaft, the devolatilizer further comprising an enclosure configured to blanket the external portion of at least one stirrer shaft seal with a low oxygen content gas or vapor,
introducing a concentrated polymer phase into the vacuum chamber;
applying a vacuum through the at least one vacuum port while rotating the stirrer shaft to agitate the concentrated polymer phase; and
blanketing the external portion of at least one of the stirrer shaft seals with a low oxygen content gas or vapor.

39. A vacuum devolatilizer for polymer manufacturing or processing, the devolatilizer comprising:
a vacuum chamber having an inlet, an outlet, at least one vacuum port, and at least one stirrer shaft port configured to accept a stirrer shaft;
a stirrer shaft passing through the at least one stirrer shaft port and extending into the vacuum chamber, the stirrer shaft including an agitation means;
a stirrer shaft seal associated with each stirrer shaft port for sealing against the stirrer shaft; and
at least one motor located outside the vacuum chamber for rotating the stirrer shaft,
wherein each stirrer shaft seal is a packed seal and is provided with a dedicated oil injection pump for injecting lubricating oil into the packed seal.

40. The devolatilizer of claim 39, wherein the housing includes two stirrer shaft ports, the stirrer shaft extends through each of those two stirrer shaft ports, each shaft port has a packed stirrer shaft seal, and the devolatilizer further includes two oil injection pumps, each oil injection pump being arranged to pump oil into the packing of one of the stirrer shaft seals.

41. The devolatilizer of claim 39, wherein the devolatilizer comprises a food grade oil for injection into the packing of each shaft seal.

42. The devolatilizer of claim 39, including a means for blanketing an external portion outside of the vacuum chamber of each shaft seal with a low oxygen content gas.

43. The devolatilizer of claim 42, wherein the means for blanketing comprises an enclosure around each shaft seal, the enclosure is mounted on the outside of the housing and is provided with a supply of low oxygen content gas or vapor.

44. The devolatilizer of claim 43, wherein each enclosure is configured to be maintained under a positive pressure of the low oxygen content gas.

45. The devolatilizer of claim 43, wherein each enclosure includes an inspection hatch.

46. The devolatilizer of claims 43, including a flow meter to monitor the flow of low oxygen content gas or vapor into each enclosure.

47. The devolatilizer of claim 39, wherein the vacuum chamber is substantially cylindrical and provided in a substantially horizontal orientation such that the axis of the cylinder lies in a horizontal plane, and the stirrer shaft also extends horizontally and coincides with axis of the cylinder.

48. The devolatilizer of claim 39, wherein each seal includes a packing comprising braided Kevlar fibers impregnated with PTFE or graphite.

49. The devolatilizer of claim 39, wherein the low oxygen content gas comprises nitrogen.

50. The devolatilizer of claim 39, wherein the internal volume of the vacuum chamber is at least 2 to 10 m³.
